(19) United States
(12) Patent Application Publication
(10) Pub. No.: US 2004/0022299 A1
(43) Pub. Date: Feb. 5, 2004

(54) Chirp waveform decoding system

(76) Inventor: Richard L. Anglin JR., Del Mar, CA (US)

Correspondence Address: Richard L. Anglin, Jr., 2115 Heather Lane, Del Mar, CA, 92614, US

(21) Appl. No.: 10/633,147

(22) Filed: Aug. 1, 2003

Related U.S. Application Data
(63) Continuation-in-part of application No. 09/212,339, filed on Dec. 15, 1998, now abandoned.

(51) Int. Cl. H04K 1/00

(52) U.S. Cl. 375/139

(57) ABSTRACT

Methods and apparatus for detecting a transmission of digital radio frequency chirps are disclosed. A series of digital chirps, which are emitted from a remote transmitter, are received by an antenna and then fed into an RF receiver. In one preferred embodiment of the invention, noise is extracted from the received RF chirp waveform using a Kalman filter. Useful information is then extracted from the received RF chirp waveform using one of several novel detection methods.

### CROSS-REFERENCE TO A RELATED PATENT APPLICATION & CLAIM FOR PRIORITY

The present Patent Application is a Continuation-in-Part Patent Application. The Applicant hereby claims the benefit of priority for any subject matter which is shared by the present Application, and by a pending commonly-owned Parent Application entitled Chirping Digital Wireless System, which was filed on Dec. 15, 1998, and which was assigned U.S. Ser. No. 09/212,339.

### INTRODUCTION

The title of this Patent Application is Chirp Waveform Decoding System. The Applicant is Richard L. Anglin, Jr. of 2115 Heather Lane, Del Mar, Calif. 92014-2244. Mr. Anglin is a U.S. citizen.

### FEDERALLY SPONSORED RESEARCH OR DEVELOPMENT

Not Applicable.

### FIELD OF THE INVENTION

The present invention relates to the field of digital communications. More particularly, this invention provides novel methods and apparatus for detecting a transmitted waveform which utilizes frequency chirps to create a binary or alphanumeric or special character data structure. Utilization of the present invention will enable efficient high bandwidth digital wireless communications leading to new markets for interactive wireless communications services, including voice, data, image, compressed video and Internet access.

### BACKGROUND OF THE INVENTION

Wireless communication systems such as cellular, Personal Communication System (“PCS”) and satellite systems such as Iridium and American Mobile Satellite Corporation (“AMSC”) have all been implemented and deployed to enable mobile voice communications. Technologies for these systems, whether analog or digital, have evolved from the voice handling requirements of the Public Switch Telephone Network (“PSTN”). Virtually all of these systems are narrowband because of the limited radio frequency (“RF”) spectrum available to each service. The channels are sized to the minimum bandwidth required to support “acceptable” voice communications. “Acceptability” means intelligibility and clarity, not necessarily the “toll” quality of the PSTN. All of these systems are symmetric, that is, two channels of equal size are required to support full-duplex voice communications.

The system parameters that are required to deliver voice services make handling digital data communications difficult. All of these systems accommodate wireless digital data communications, but the data throughput rates are very low and the additional equipment required can be complex because of the network switching requirements.

The advent of the Internet has ushered a fundamental paradigm shift in the way in which information is collected, stored, displayed, accessed and distributed. The Internet has taken over, with the Web browser rapidly becoming the user template for communications, information and even entertainment. This feature-rich multimedia environment has led to bandwidth demands which traditional wireline telecommunications networks struggle today to meet.

For example, information formerly presented in catalogs resides in World Wide Web (“WWW” or “Web”) sites and is available for viewing via a Web browser, printing to a local printer or downloading as a file to a local personal computer (“PC”). Electronic mail (“e-mail”) has become the de rigeur for business and is widely used by consumers.

The historical model of centralized corporate information databases has been replaced by dispersed local servers interconnected via high-speed telecommunications networks. The increasing mobility and globalization of business requires virtually instantaneous access to this information wherever it may reside. Mobile workers are expected to have the same access as workers in fixed locations. Go to any major airport in the world and observe countless travelers toting laptop PCs. In seeking to make waiting time productive they are constantly looking for data ports to plug in their laptops to access the Internet.

Wireless communications carriers, terrestrial and satellite, are today seeking technologies to support this major paradigm shift to the Internet. They are constrained, however, by the narrowband, low speed, symmetrical character of deployed wireless communication systems.

Eavesdrop on any conversation about the Internet and the topic of access speed invariably comes up. The great majority of people are talking about access speed at their business or home. Access speed is addictive. Once having access to higher Internet speeds, users resist, often to the point of avoidance, lower speed technologies (even for just e-mail). When it comes to wireless Internet access there are no high speed alternatives.

Consider a typical mobile Internet session. The user logs onto the Internet and first requests download of his or her e-mail messages. The request to the electronic mail server is a very small message. The download can be quick if there are only a few messages and the messages themselves are small. However, if there are a large number of messages or the messages contain a large amount of text, downloading can take a very long time. Downloads are even slower if the messages have files appended to them, and slower still if the files are graphic images or video.

This user is a corporate salesperson and needs to download a product brochure. Again, the request to the database server is a small message, but the download file is large. The download process maybe extremely slow if the file contains embedded images in color.

There is a tremendous and rapidly increasing need for a wireless communication system to support high speed mobile digital data communications. The desired system should be asymmetric; providing high bandwidth for downloading information and small bandwidth for uploading message requests and electronic mail. However, high bandwidth should also be available if the user needs to upload a large file. Thus, the desired wireless digital data communications system should be able to dynamically allocate bandwidth to users to accommodate their particular requirements at any given point in time.

### SUMMARY OF THE INVENTION

The present invention provides methods of detecting chirp radio frequency (“RF”) waveforms. The generation of these novel chirp waveforms is disclosed in a pending U.S. patent application Ser. No. 09/212,339, entitled Chirping Digital Wireless System, which was filed on Dec. 15, 1998.

The present invention includes an antenna and an RF receiver for receiving a transmitted chirp RF waveform signal. The received chirp RF waveform contains noise which must be separated from the signal to extract useful information. In one embodiment of the invention, the RF noise is removed from the received chirp RF waveform using a Kalman filter. This filtering process results in a filtered RF waveform. At this point, useful information is extracted from the filtered waveform by employing one of several novel alternative detection methods. In one embodiment of the disclosed invention, after the detection step is complete, the filtered RF waveform is converted to a series of intermediate frequency (“IF”) pulses that correlate with the original chirps that were transmitted to the RF receiver. The IF pulses are then conditioned to a series of square wave signals, yielding a digital output which conveys intelligible information; the same information that was transmitted.

An appreciation of the other aims and objectives of the present invention and a more complete and comprehensive understanding of this invention may be obtained by studying the following description of preferred and alternative embodiments, and by referring to the accompanying drawings.

### A BRIEF DESCRIPTION OF THE DRAWINGS

FIG. 1 shows a linear frequency up-chirp and a down-chirp.

FIG. 2 shows a linear frequency up-down-chirp and a down-up-chirp.

FIG. 3 shows a linear frequency plus-chirp and a linear frequency minus-up-chirp.

FIG. 4 shows a functional block diagram of the Chirping Digital Wireless System.

FIG. 5 shows a functional block diagram of a chirping receiver system.

FIG. 6 shows linear frequency chirp waveforms.

FIG. 7 shows an embodiment of the disclosed invention comprising frequency-to-voltage detection for up-chirps and down-chirps.

FIG. 8 shows an embodiment of the disclosed invention comprising frequency-to-voltage detection for up-down-chirps and down-up-chirps.

FIG. 9 shows an embodiment of the disclosed invention comprising a digital method of detection by comparing patterns of zero crossings of waveforms.

FIG. 10 shows an embodiment of the disclosed invention comprising an analog method of detection by comparing patterns of zero crossings of waveforms.

FIG. 11 shows an embodiment of the disclosed invention comprising a digital method of detection by comparing the shortest and longest zero crossing intervals of waveforms.

FIG. 12 shows an embodiment of the disclosed invention comprising an analog method of detection by comparing the shortest and longest zero crossing intervals of waveforms.

FIG. 13 shows an embodiment of the disclosed invention comprising integration of the waveforms.

FIG. 14 shows an embodiment of the disclosed invention comprising rectification and integration of the waveforms.

FIG. 15 shows an embodiment of the disclosed invention comprising subtractive integration and comparison to known waveform.

FIG. 16 shows an embodiment of the disclosed invention comprising subtractive integration and comparison to known waveform using a complementary output pulse.

FIG. 17 shows an embodiment of the disclosed invention comprising additive integration and comparison to known waveform.

FIG. 18 shows an embodiment of the disclosed invention comprising additive integration and comparison to known waveform using a complementary output pulse.

FIG. 19 shows an embodiment of the disclosed invention comprising out of phase chirps.

FIG. 20 shows an embodiment of the disclosed invention comprising time phased reception.

FIG. 21 shows an embodiment of the disclosed invention for very short chirp waveforms.

FIG. 22 shows an embodiment of the disclosed invention comprising multiple frequency down shifting.

FIG. 23 shows an embodiment of the disclosed invention comprising a sloped filter for detecting up-chirps and down-chirps.

FIG. 24 shows an embodiment of the disclosed invention comprising a sloped filter for detecting up-down-chirps and down-up-chirps.

FIG. 25 shows an embodiment of the disclosed invention comprising delay elements to detect up-chirps and down-chirps.

FIG. 26 shows an embodiment of the disclosed invention comprising delay elements for detecting up-down-chirps and down-up-chirps.

### A DETAILED DESCRIPTION OF PREFERRED & ALTERNATIVE EMBODIMENTS

Overview of the Invention

A “chirp” is generally defined as a waveform or propagated signal which may be characterized by a mathematical function. In one embodiment of the invention, the mathematical function is a relationship between the frequency of the chirp and time. The chirp interval (“T”) is defined as the time between the beginning of one chirp and the beginning of the succeeding chirp. The chirp period (“t”) is defined as the duration of a chirp.

Impression of a digital structure to such a signal can be accomplished by defining a binary one (1) to be an up-chirp and a binary zero (0) to be a down-chirp, vice versa, or combination thereof. A digital signal can then be sent using a stream of up- and down-chirps. The data rate for the digital stream is determined by the time interval between the start of successive chirps. Very high data rates can be achieved with today's semiconductor technology.

The receiver of the information has a priori knowledge of the transmitted waveform. This means that a great deal of dispersion and noise can be tolerated in conjunction with the signal.

One of the principal advantages of the chirping technology is that the digital information is encoded continuously across the chirp allowing more robust detection techniques that are not dependent on the detection of the edge of the transition from a “0” to a “1” or from a “1” to a “0”. In standard digital encoding techniques the faster the attempt to make the transition, the sharper the edge, the more likely that the edge will be blurred, missed or improperly identified, and information will be lost. By encoding the information in a continuous manner in the up or down nature of the chirp it is less likely that the transition from a “1” to a “0” or from a “0” to a “1” will be missed, since the detector has more chances and time to discover and to identify the distinction. The inventions disclosed in this Specification all take advantage of this fact. A number of alternative methods are available to detect the transmitted waveform.

Preferred & Alternative Embodiments

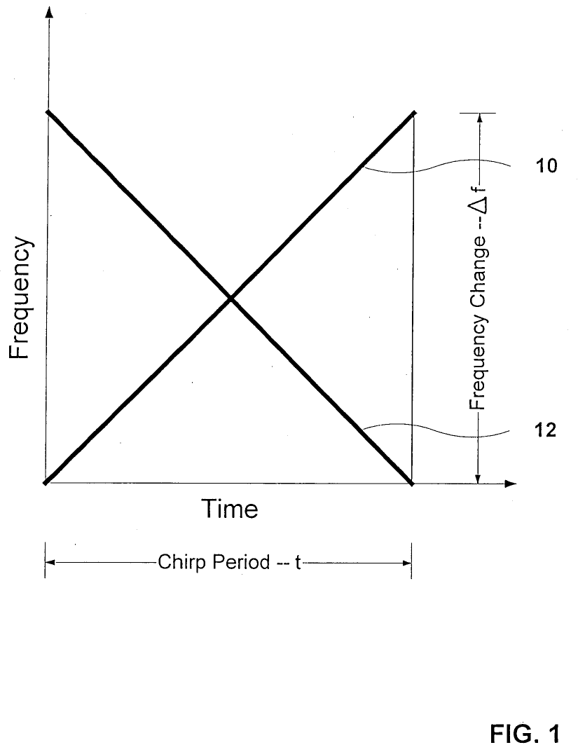

FIG. 1 shows a linear frequency up-chirp 10 and a linear frequency down-chirp 12. These chirps are defined by their frequency change (“Δf”) and chirp period (“t”).

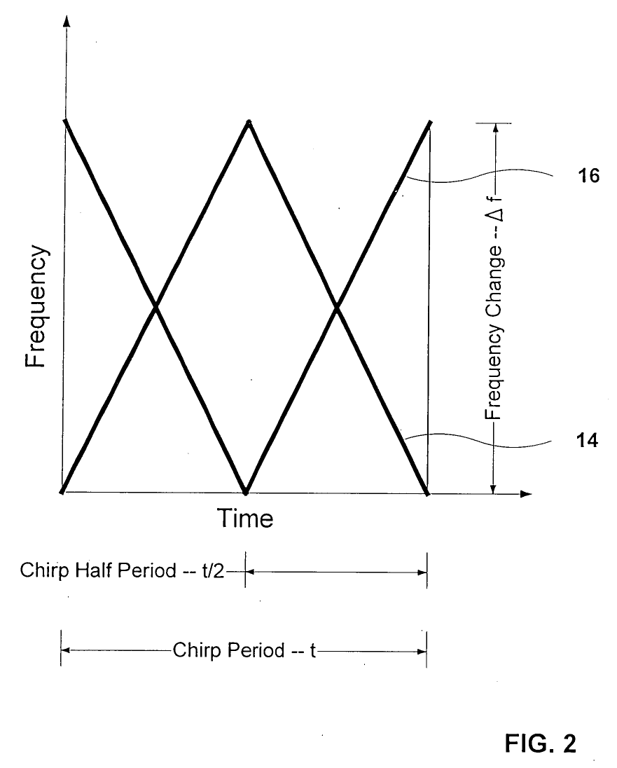

FIG. 2 shows a linear frequency up-down-chirp 14 and a linear frequency down-up-chirp 16. These chirps are also defined by their frequency change (“Δf”) and chirp period (“t”).

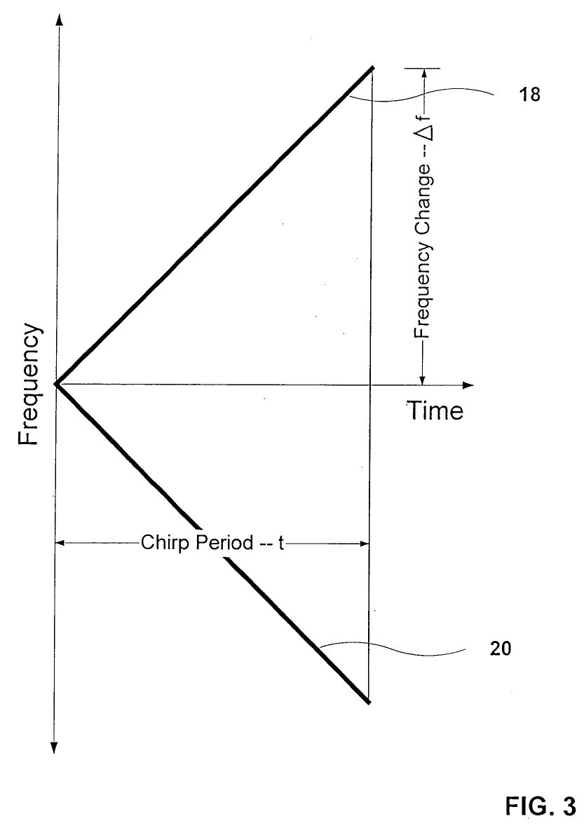

FIG. 3 shows a linear frequency plus-chirp 18 and a linear frequency minus-up-chirp 20. These chirps are likewise defined by their frequency change (“Δf”) and chirp period (“t”).

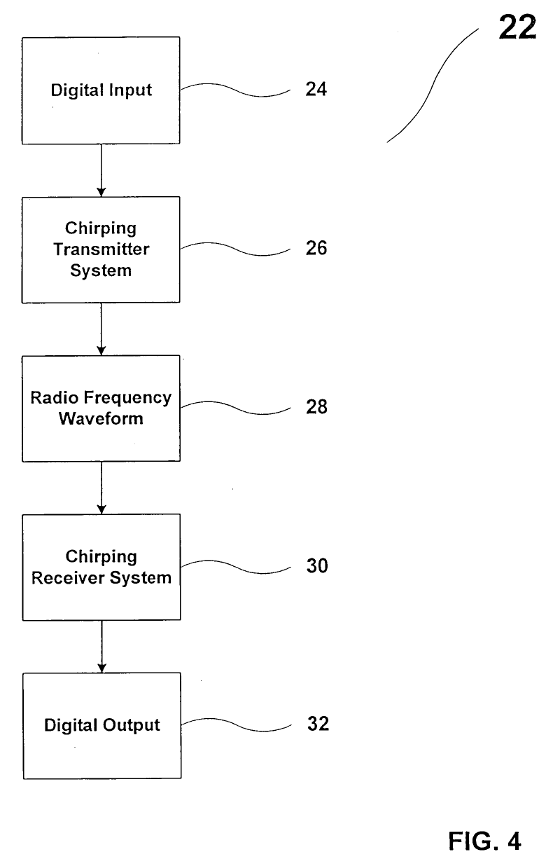

FIG. 4 shows a functional block diagram of the invention 22 disclosed in the Chirping Digital Wireless System as shown in pending U.S. patent application Ser. No. 09/212,339. A digital input 24 is fed to a chirping transmitter system 26 that generates the chirping radio frequency (“RF”) waveform 28. The transmitted chirping radio frequency waveform 28 is received by a chirping receiver system 30 which generates a digital output 32 that recreates the digital input 24.

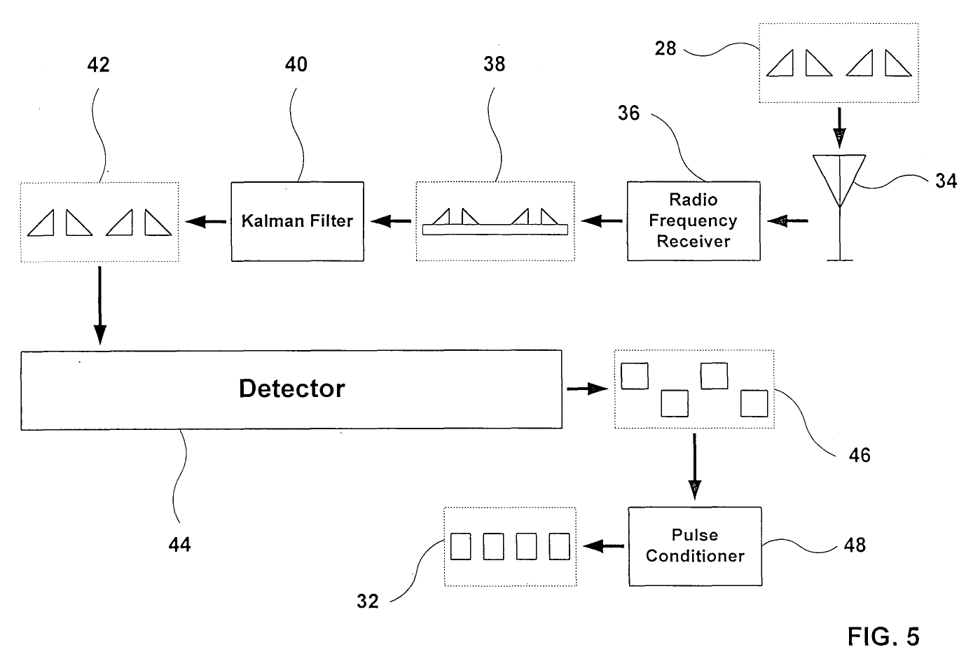

FIG. 5 shows a functional block diagram of a chirping receiver system 30. The chirping RF waveform 38 is received by an antenna 34 and RF receiver 36. The received RF input waveform 38 comprises both the RF output waveform 28 as well as RF noise resulting from the wireless transmission. The RF noise is removed from the RF input 38 using a Kalman filter 40 resulting in a filtered RF input waveform 42. The filtered RF input waveform 42 is detected using one or more of the methods disclosed herein. The result is intermediate frequency (“IF”) pulses 46 that correlate with input chirps. The IF pulses 46 are conditioned 48, that is, conformed to square wave, to yield the digital output 32.

Detection Methods

All methods for detecting chirps assume a base frequency with a chirp added. The base frequency is fₒ; the difference between the base frequency and the upper chirp frequency is Δf. For example, a chirp could go from 912 MHz to 913 MHz, so the signal could be thought of as a 912 MHz base signal, fₒ, with a 0-to- 1 MHz, Δf, chirp added to the base signal. Note that this is, in theory, no different from a chirp that goes from fₒ to fₒ+Δf. Also note that, in this notation, Δf is always positive. The time interval over which the frequency changes from 0 to Δf is the chirp period t.

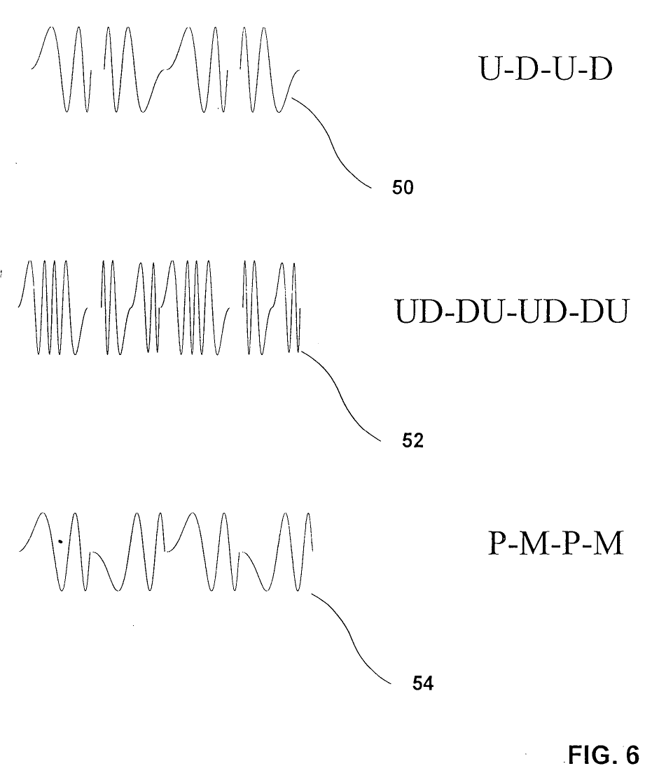

FIG. 6 shows three (3) linear chirp (1,0) waveform pairs for digital data transmission:

Up-Chirp (“U”)/Down Chirp (“D”) 50,

Up-Down-Chirp (“UD”)/Down-Up-Chirp (“DU”) 52, and

Plus-Chirp (“P”)/Minus-Chirp (“M”) 54.

FIG. 1 shows a linear frequency up-chirp 10 and a liner frequency down-chirp 12. The Up-Chirp (“U”) goes from 0 to Δf in time t. The Down-Chirp (“D”) goes from Δf to 0 in a time t.

FIG. 2 shows a linear frequency up-down-chirp 14 and a linear frequency down-up-chirp 16. The Up-Down-Chirp (“UD”) 14 goes from 0 to Δf in time t/2 and then immediately from Δf to 0 in time t/2 so that the entire Up-Down-Chirp 14 occurs in a time t. The Down-Up-Chirp (“DU”) 16 goes from Δf to 0 in a time t/2 and then immediately from 0 to Δf in a time t/2 so that the entire Down-Up-Chirp 16 occurs in time t.

FIG. 3 shows a linear frequency Plus-Chirp (“P”) 18 and a liner frequency Minus-Chirp (“M”) 20. The Plus-Chirp 18 can be either an Up-Chirp or a Down-Chirp while the Minus-Chirp is its complement, that is, the phase of the Minus-Chirp lags the phase of the Plus-Chirp by one hundred eighty degrees (180°). The result of this is that adding a Plus-Chirp 18 to a Minus-Chirp 20 gives zero. The two signals are in that sense orthogonal. In this Specification and in the claims that follow, the Plus-Chirp (“P”) 18 is an Up-Chirp (“U”) and the Minus-Chirp (“M”) 20 is the compliment of an Up-Chirp in all of the figures. All of the methods discussed in this Specification that apply to Plus(Up)Chirp/Minus(-Up)Chirp pairs also apply exactly to Plus(Down)-Chirp/Minus(-Down)-Chirp pairs.

It is assumed that the input 42 to the detector 44 has been properly conditioned, amplified and filtered so that only the base frequency and the chirp enter the detector and that the waveform 42 amplitude is normalized. It is also assumed that the input signal and the decoding circuit are synchronized, that is, the input chirp pulse begins as the decoding circuit is ready to begin. In addition, the chirp period is adjusted so that the Up-Chirp (“U”) starts at zero voltage with a positive slope and ends at zero voltage with a positive slope.

The types of chirp signal pairs that the particular method is applicable to is shown in parentheses following the identifying name of the decoding method. For example, the first method is called Frequency to Voltage conversion. It will work with the U/D pair of chirps 50 and with the UD/DU pair 52, but not with the P/M pair 54. So “U/D” and “UD/DU” are shown in parentheses after the title “Frequency to Voltage.”

All of the detection methods may be implemented in either digital electronics, analog electronics or a mixture of the two depending on the frequencies being used for fₒ and Δf.

I. Frequency to Voltage (U/D 50 and UD/DU 52)

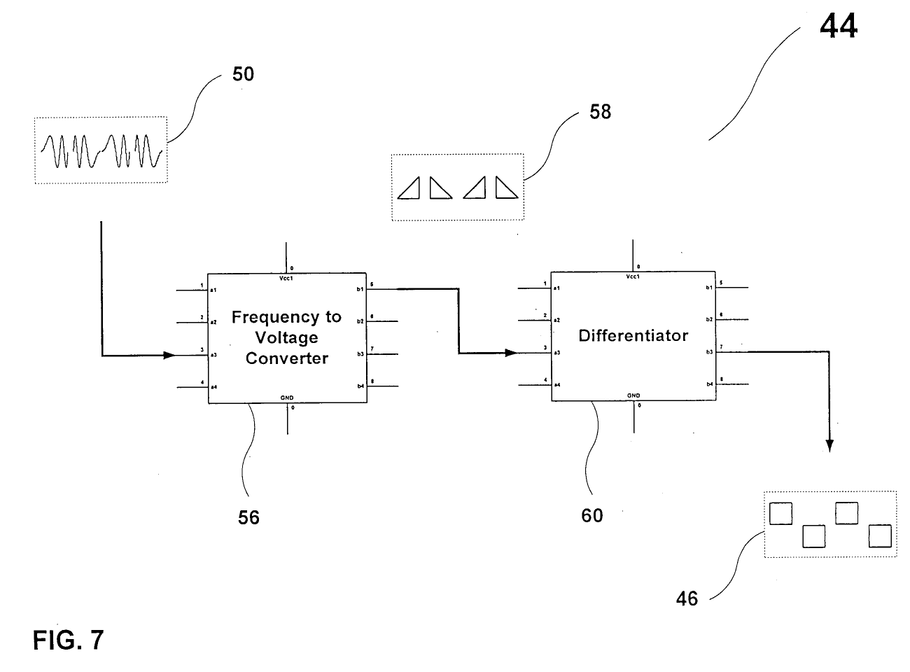

The first embodiment of the disclosed invention comprises down converting the incoming signal by subtracting fₒ from the signal in exactly the same manner that a Frequency Modulation (“FM”) demodulator works. This results in a series of U and D 50 or UD and DU 52 pulses containing frequencies between 0 and Δf that are then sent to a frequency-to-voltage (“F/V”) converter 56. The TelCom TC 9400 works between 0 and 100 kHz. Similar devices can be built for higher frequencies if not available commercially. FIG. 7 shows the instant embodiment of the disclosed invention 44 for a series of U and D pulses 50. The output waveform 58 of the F/V converter 56 is a linearly rising voltage as a function of time for the U pulse, or a linearly falling voltage as a function of time for the D pulse. These triangular shaped pulses can then be differentiated 60 to give square pulses 46, positive for the U chirp and negative for the D chirp.

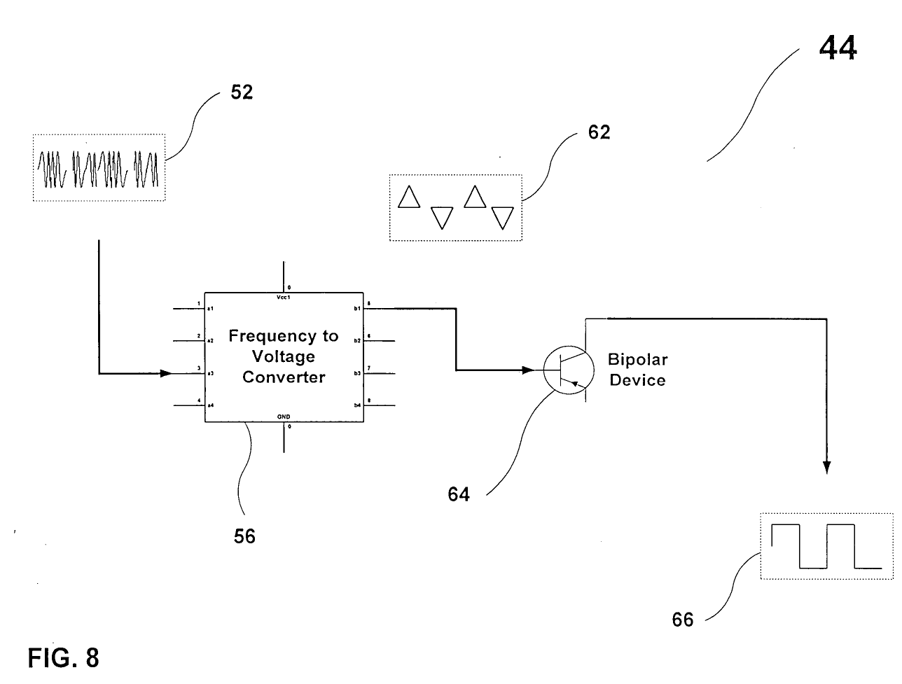

FIG. 8 shows the instant embodiment of the disclosed invention 44 for a series of UD and DU pulses 52. The output waveform 62 of the F/V converter 56 is a linearly rising then falling voltage as a function of time for the UD pulse, or a linearly falling then rising voltage as a function of time for the DU pulse. These waveforms are then fed into a bistable device 64 that triggers when the voltage passes through a given value. The device is triggered on as the voltage increases and off as the voltage decreases. The circuit is designed to result in a positive square pulse for the UD pulse and a negative square pulse for the DU pulse 66.

II. Compare Patterns of Zero Crossings of Wave Forms

(U/D 50 and UD/DU 52)

A second embodiment of the disclosed invention 44 is to determine the zero crossings of the waveform and to measure and compare the zero crossing intervals to the known patterns for U/D 50 or UD/DU 52 chirps. The output corresponds to the success of the match.

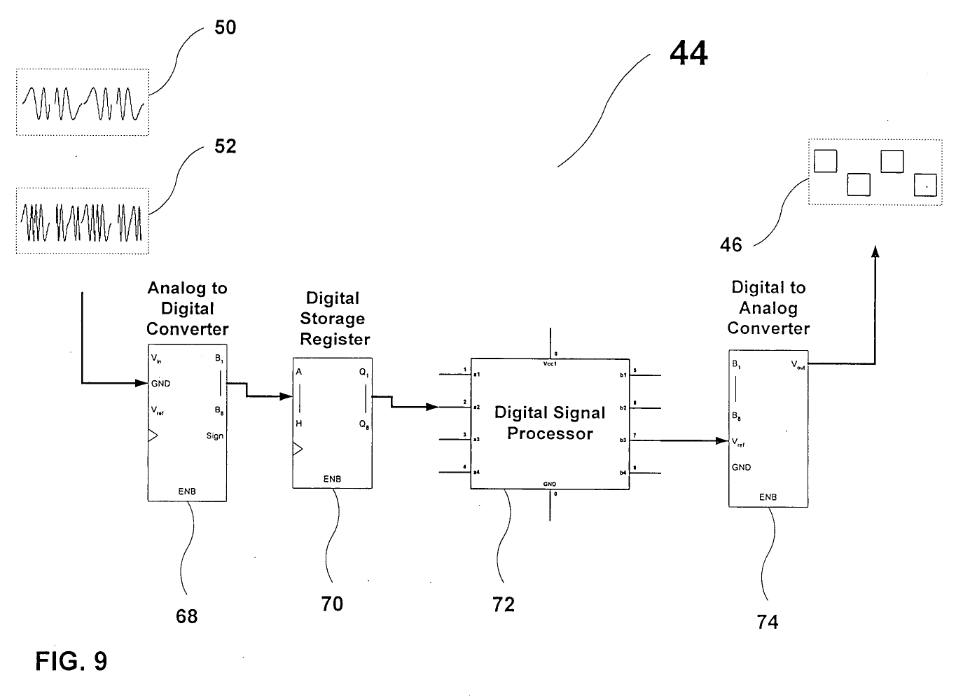

FIG. 9 shows a digital method to determine the zero crossings of the U/D 50 and UD/DU 52 waveforms, that is, digitize the incoming signal, interpolate the zero crossings, compare these values to a table defining the known values, and output a positive or negative square pulse as appropriate. The received waveforms are input to an analog-to-digital (“A/D”) converter 68. The converted digital signal is stored 70 and then input to a digital signal processor (“DSP”) 72. The DSP output is input to a digital-to-analog (“D/A”) converter 74 which produces the square pulses 46.

An analog method to determine the zero crossings of the U/D 50 and UD/DU 52 waveforms is to trigger a bistable device every time the voltage crosses zero. This results in a distinct pattern of square pulses for each unique chirp waveform. Each square wave pulse is then integrated. Because the voltage for all pulses is a constant, the integral for each pulse is proportional to the time length of the individual square pulse. The values are then compared to the distinct patterns of known voltages (time intervals) for each type of chirp and a positive or negative pulse is output as appropriate.

This is accomplished in practice by having several bistable devices that require the appropriate voltage (time interval) to switch. If all for a given pattern switched at the appropriate time then logic networks generate either a positive or a negative square pulse as appropriate.

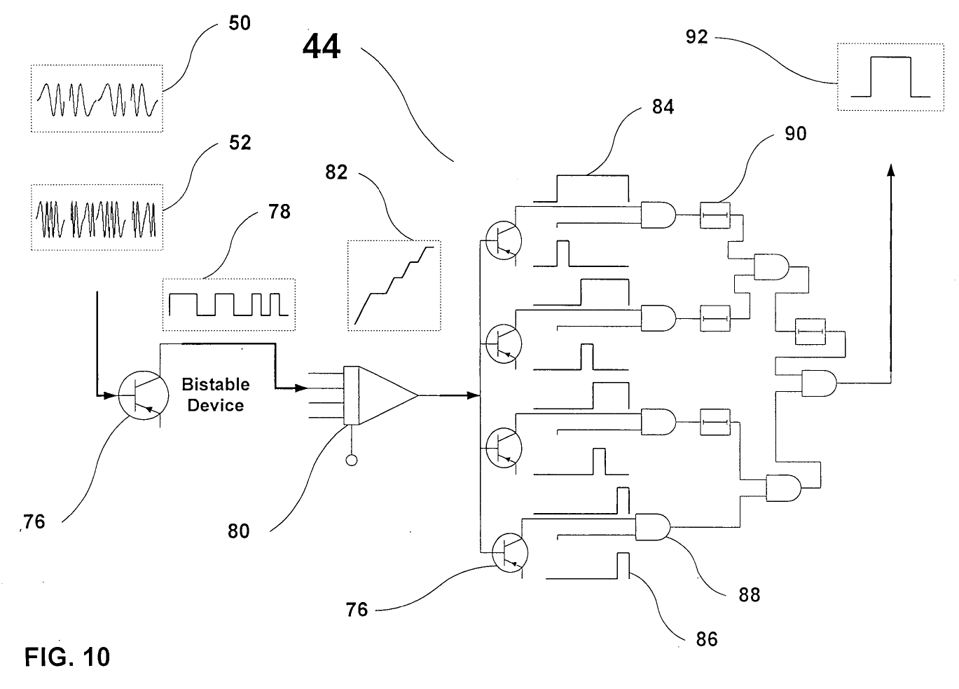

FIG. 10 shows an analog method to determine the zero crossings of the U/D 50 and UD/DU 52 waveforms. The U/D 50 or UD/DU 52 waveform is input to a bistable device 76 that generates a zero crossing pattern 78. The zero crossing pattern is integrated 80 to produce an integrated output 82. The integrated output 82 is fed to two decoding networks, one for decoding a “zero” and one for decoding a “one.” FIG. 10 shows only one of these networks, the network for decoding a “one.”

The integrated output 82 is fed to a plurality of bistable devices 76. Each of these bistable devices 76 produces a bistable output 84 referenced against a timing pulse 86. Each bistable output 84 is input to an AND device 88. Succeeding bistable outputs 84 are input to delay elements 90 and then to AND devices 88. The resultant output 92 is a single pulse, here representing a “one.”

The incoming signal may or may not have to be down converted depending on available components.

III. Compare Shortest and Longest of Zero Crossing Intervals of Wave Forms

(U/D 50 and UD/DU 52)

The zero crossings of the wave form are determined as described above. A third embodiment of the disclosed invention 44 is to measure the first and last zero crossing intervals for U/D and measure the first and middle crossing intervals for UD/DU. The output corresponds to the success of the match.

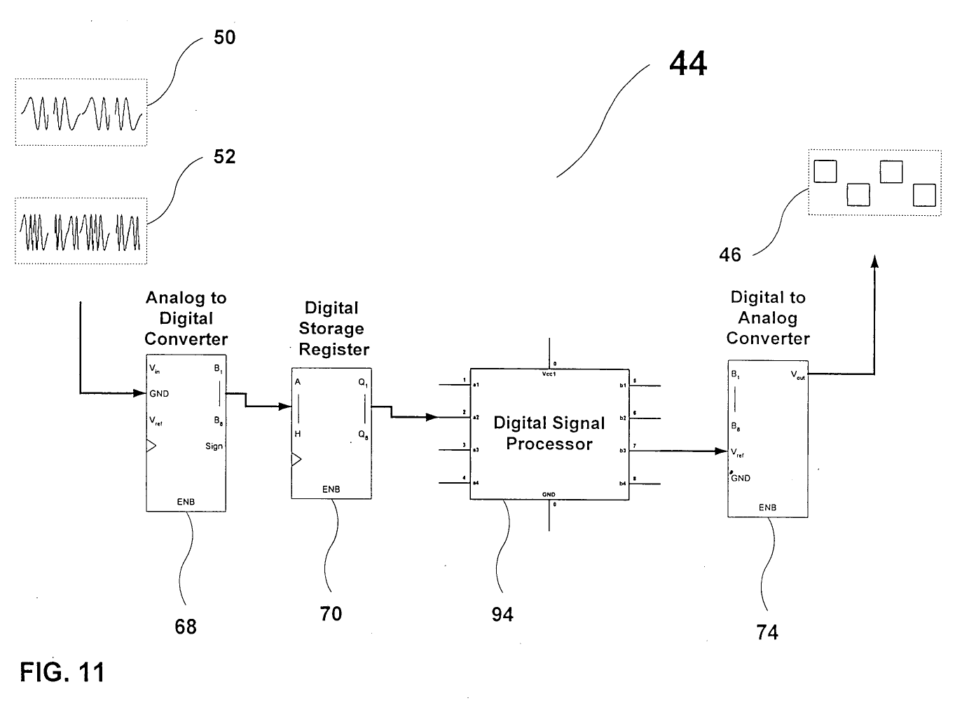

A digital method for accomplishing this is to digitize the incoming signal, interpolate the appropriate zero crossings, and compare the lengths of the appropriate crossing intervals as shown in FIG. 11. FIG. 11 is identical to FIG. 9 except for the different parameters used in the DSP 94. For U/D 50 if the first is longer, output a positive square pulse and if the last is longer output a negative square pulse.

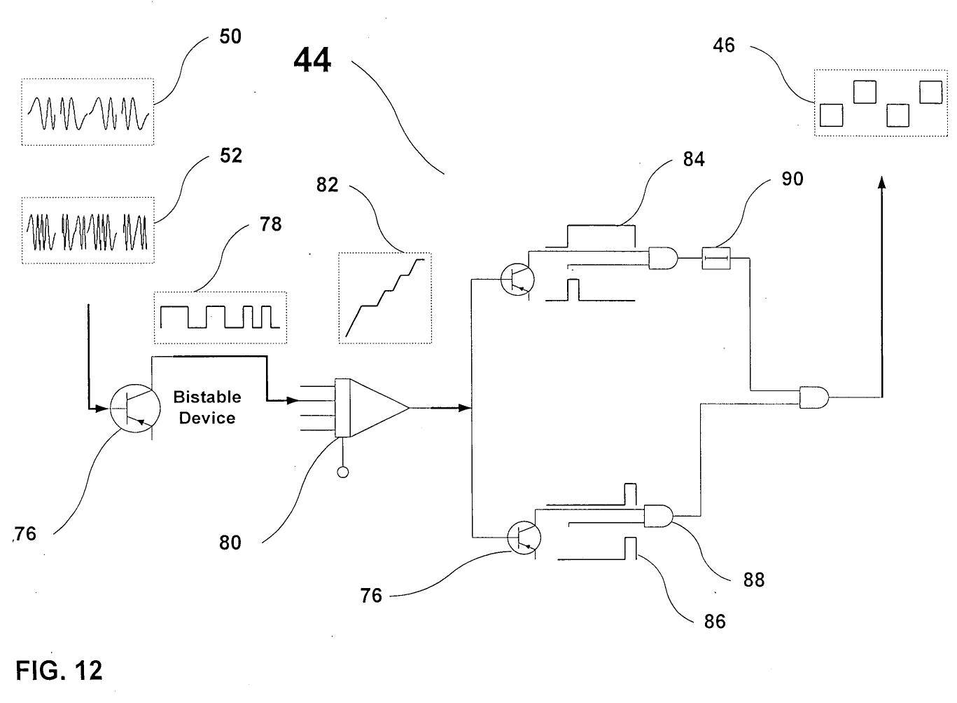

An analog method is to trigger a bistable device every time the voltage crosses zero as shown in FIG. 12. This results in a distinct pattern of square pulses 78 for each unique chirp waveform. Each square wave pulse is then integrated 80. Because the voltage for all pulses is a constant the integral for each pulse is proportional to the time length of the individual square pulse. The values are then compared to the distinct patterns of known voltages (time intervals) for each type of chirp and a positive or negative pulse is output 46 as appropriate. This is accomplished in practice by having two (2) bistable devices 76 that require the appropriate voltage (time interval) to switch. If both switch then a positive or negative square pulse is output as appropriate.

The incoming signal may or may not have to be down converted depending on available components.

IV. Integrate Waveform

(U/D 50 and P/M 54)

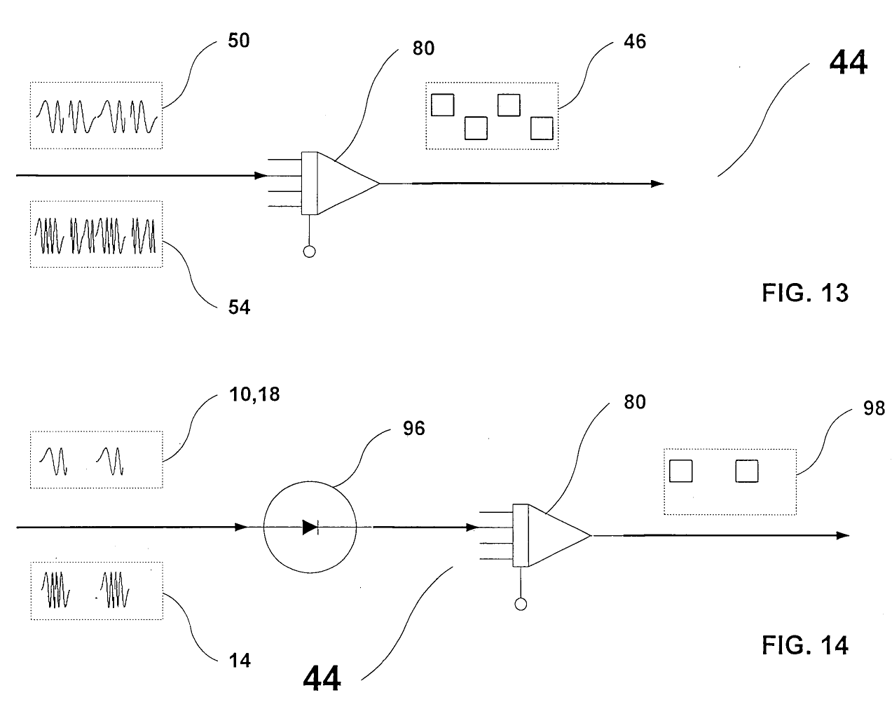

A fourth embodiment of the disclosed invention 44 is to integrate 80 the incoming waveform 50,54 as shown in FIG. 13. A U 10 or P 18 waveform will have a positive integral because as the period decreases, each succeeding negative cycle is slightly shorter than the preceding positive cycle. A D 12 or M 20 waveform will have a negative integral. The resulting integral thus gives the correct square pulse 46 for the incoming signal.

V. Use Only Waveforms for One (Not Zero), Rectify and Integrate

(U 10, UD 14, P 18)

The Up-Chirp 10, Up-Down-Chirp 14, and Plus-Chirp 18 (in this case the same as the Up-Chirp) are used to represent a “one.” A “zero” is represented as an absence of signal. A fifth embodiment of the disclosed invention 44 as shown in FIG. 14 is to rectify 96 the incoming waveform and integrate 80 it to give a pulse corresponding to a “one” pulse 98.

VI. Subtractive Integration Comparison to Known Wave Form

(U/D 50, UD/DU 52, P/M 54)

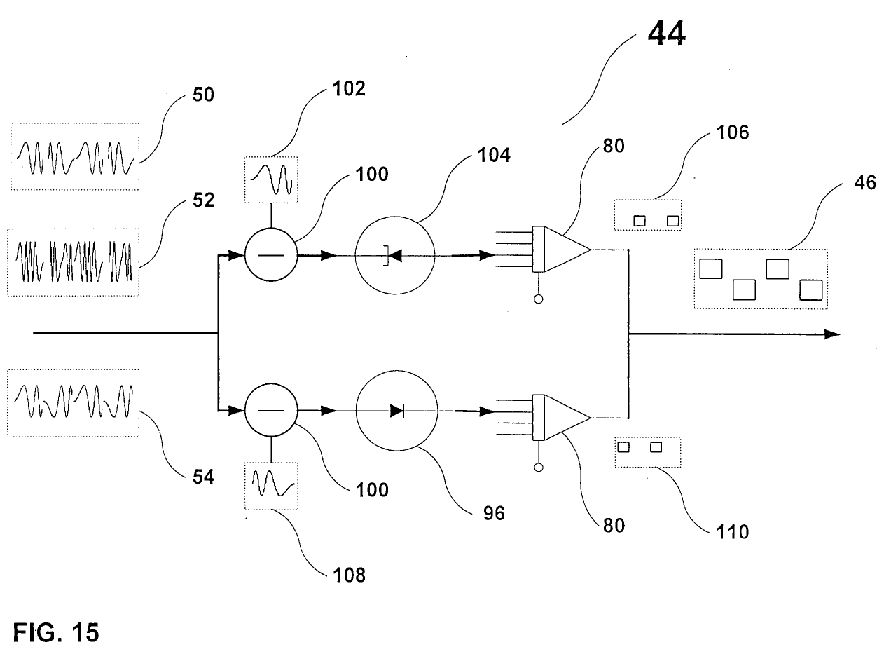

As shown in FIG. 15, a sixth embodiment of the disclosed invention 44 is to split the incoming signal and send it to two circuits: the “one” comparison circuit and the “zero” comparison circuit. In the “one” comparison circuit, the signal is subtracted 100 from the appropriate known “one” chirp wave form 102. The voltage difference is negatively rectified 104 and integrated 80. If the input is “one” chirp, the output is zero; if the input is a “zero” chirp, the output is a negative pulse 106.

In the “zero” comparison circuit, the signal is subtracted 100 from the appropriate known “zero” chirp wave form 108. The voltage difference is rectified 96 and integrated 80. If the input is a “zero” chirp, the output is zero; if the input is a “one” chirp, the output is a positive pulse 110.

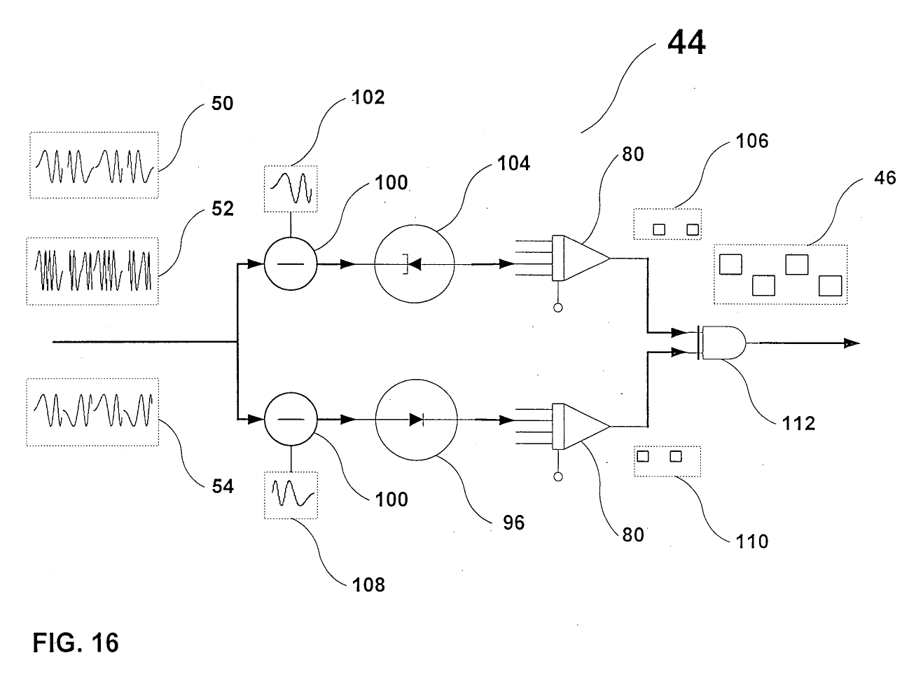

A simple variation shown in FIG. 16 is to check to see if the other comparison circuit has a complimentary output pulse by inputting the negative pulse 106 and the positive pulse 110 to an NAND gate 112. Thus, if the “one” comparison circuit has a small output pulse and the “zero” comparison circuit has a large output pulse, then the incoming pulse is a one. If the “zero” comparison circuit has a small output pulse and the “one” comparison circuit has a large output pulse then the incoming pulse is a zero.

VII. Additive Integration Comparison to Known Wave Form

(U/D 50, UD/DU 52, and P/M 54)

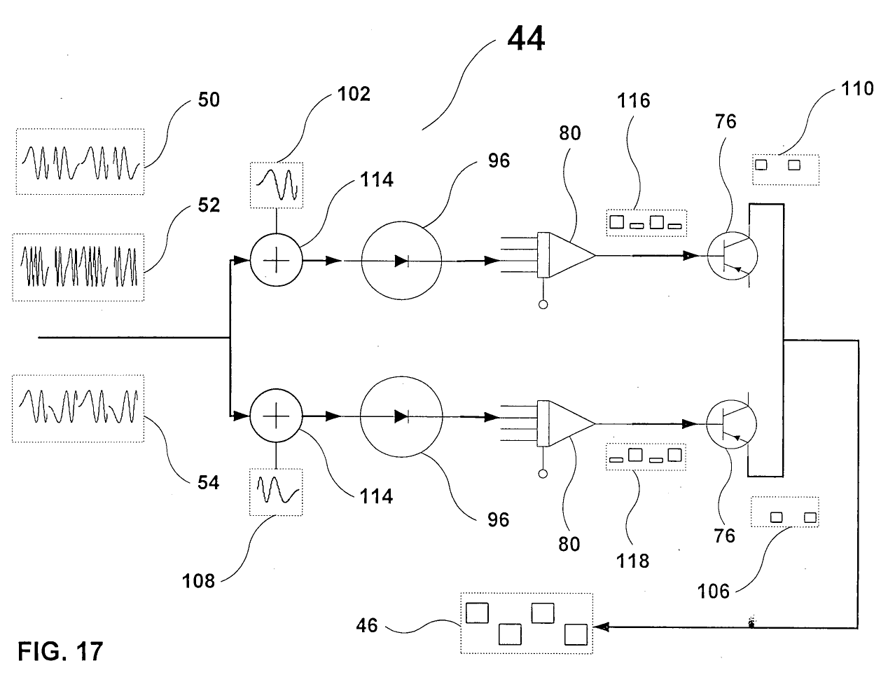

As shown in FIG. 17, a seventh embodiment of the disclosed invention 44 is to split the incoming signal and send it to two circuits: the “one” comparison circuit and the “zero” comparison circuit. In the “one” comparison circuit, the signal is added 114 to the appropriate known “one” chirp wave form 102. The voltage sum is rectified 96 and integrated 80. If the input is a “one” chirp, the voltage output is large; if the input is a “zero” chirp, the voltage is small 116. The signal is then input to a bistable device 76 that is set to trigger at a voltage between the two (2) possible outputs. Thus, only a “one” pulse will trigger an output 10. The bistable device is reset a fixed time after it is triggered.

In the “zero” comparison circuit, the signal is added 114 to the appropriate known “zero” chirp wave form 108. The voltage difference is rectified 96 and integrated 80. If the input is a “zero” chirp, the voltage output is large; if the input is a “one” chirp, the voltage is small 118. The signal is then input to a bistable device 76 that is set to trigger at a voltage between the two (2) possible outputs. Thus, only a “zero” pulse will trigger an output 106. The bistable device is reset a fixed time after it is triggered.

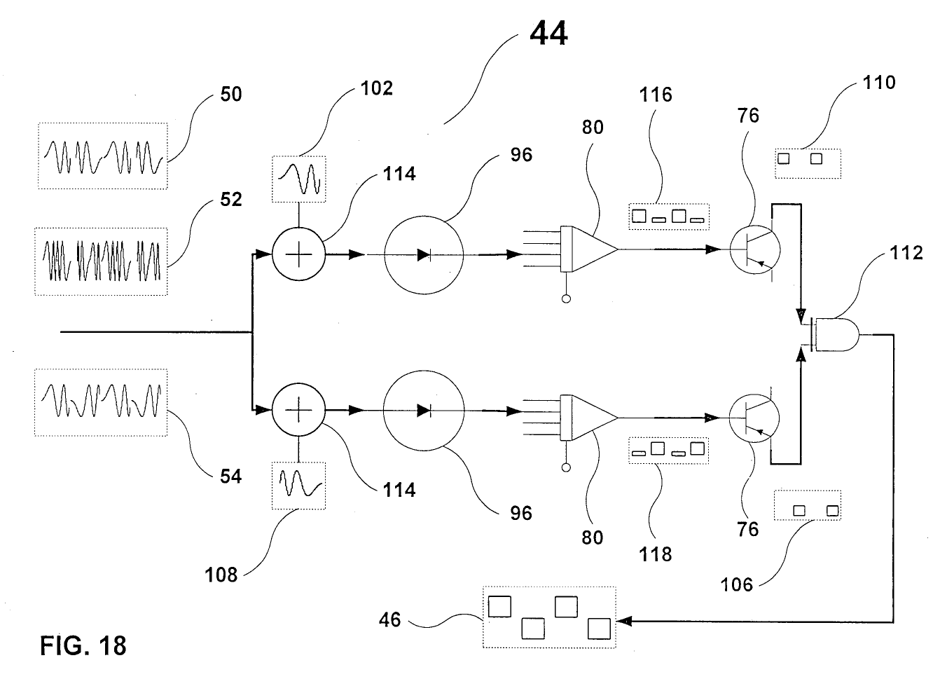

A simple variation shown in FIG. 18 is to check to see if the other comparison circuit has a complimentary output pulse by inputting the negative pulse 106 and the positive pulse 110 to an NAND gate 112. Thus, if the “one” comparison circuit has a large output pulse and the “zero” comparison circuit has a small output pulse, then the incoming pulse is a one. If the “zero” comparison circuit has a large output pulse and the “one” comparison circuit has a small output pulse then the incoming pulse is a zero.

VIII. Out of Phase Chirps

(P/M 54)

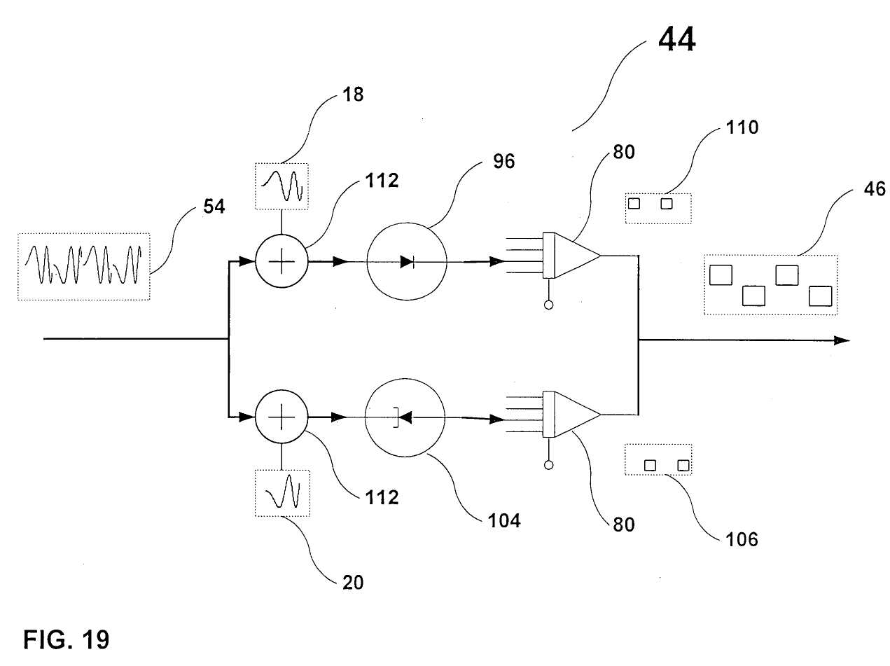

Because a “one” is an Up-Chirp 10 and a “zero” is its complement, the Up-Chirp 10 shifted by a phase of 180°, then adding 112 the input signal to a P waveform 18, rectifying 96 and integrating 80 will give a large output pulse if the input is a P 18 and a small output if the input is an M 20. This is the eighth embodiment of the disclosed invention 44 and is shown in FIG. 19.

IX. Time Phased Reception

(U/D 50, UD/DU 52)

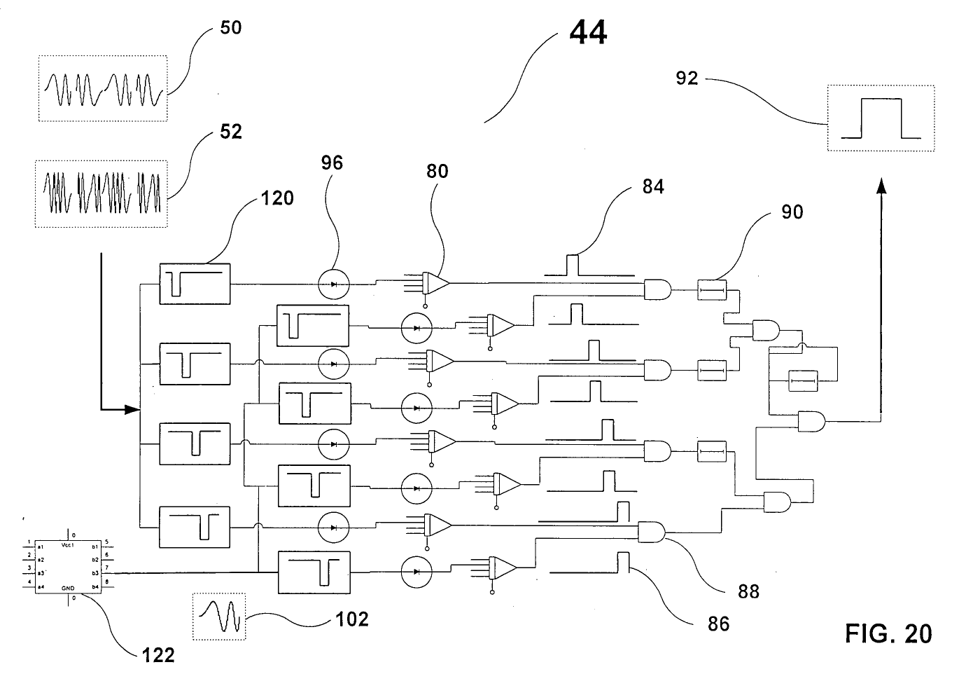

In the ninth embodiment of the disclosed invention 44 shown in FIG. 20 the input signal 50,52 is fed through a number of non-overlapping notch filters 120 that cover the chirp frequency interval. The outputs of the filters are each rectified 96 and integrated 80 and sent into an AND junction 88 gated by a generated 122 signal 102 timed to the sweep of the chirp 86. The output of the AND gates 84 is fed into an AND gate array so that only if all of the frequency inputs occur in the proper order at the proper interval is the output a positive pulse corresponding to the “one” chirp 92. An identical circuit but with the gating signal set to a “zero” chirp sequence decodes the “zero” chirp. The circuit is identical to that shown in FIG. 20 but is not shown here.

A particular advantage of this embodiment is its ability to detect the proper waveform when a strong, on-frequency interfering signal is present. Because the voltage is constant across all of the filters, a strong interfering signal will cause the voltage of that filter to be high. The excess voltage may simply be ignored. Or, because the voltage across the filters is a known constant value, the excess voltage may be subtracted from the total voltage. In a commercial embodiment of the invention, these two circuits operate in parallel.

X. Very Short Chirps

(P/M 54)

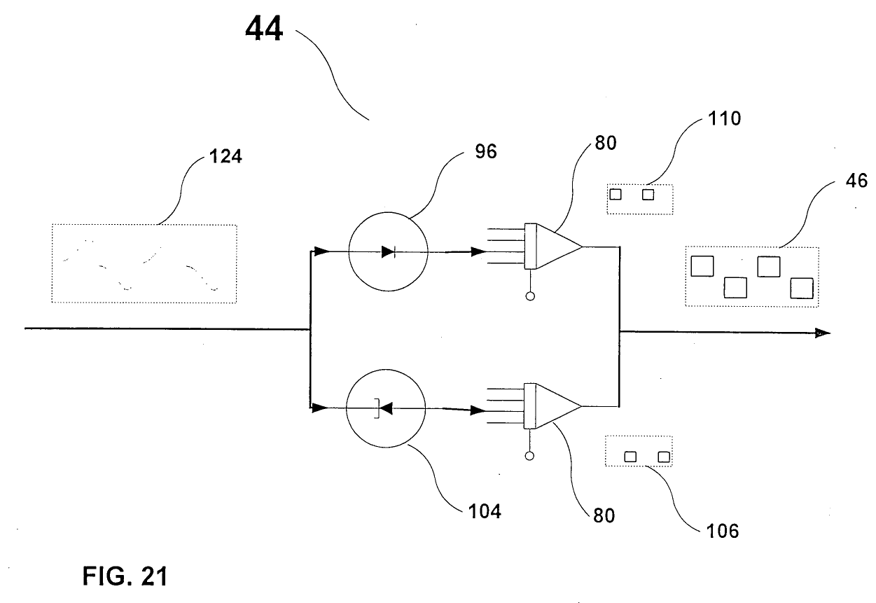

If the chirp period t is short compared to one over the chirp width Δf, the signal frequency change, [1/Δf] the waveform is very abbreviated 124. In fact it looks like a pulse as is shown in FIG. 21. If the input signal is down shifted from the base frequency and a “one” is an Up-Chirp 10 and a “zero” is the compliment, the resulting waveform is either an up pulse 110 or a down pulse 106. No decoding is necessary in this tenth embodiment of the disclosed invention 44.

XI. Multiple Frequency Down Shift

(U/D 50, UD/DU 52)

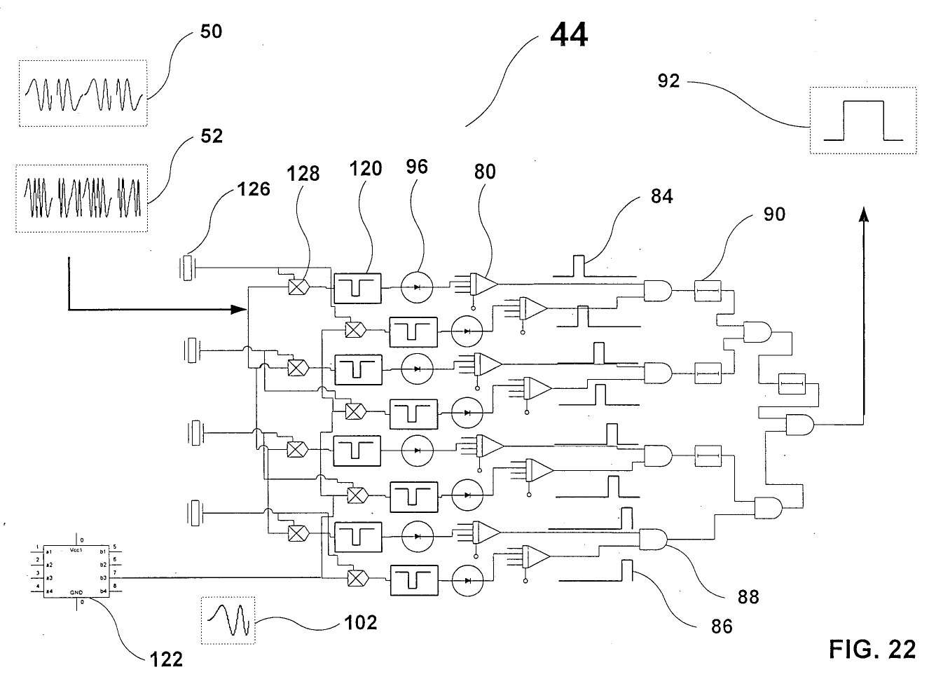

In the eleventh embodiment of the disclosed invention 44 shown in FIG. 22 the input waveform 50,52 is split into N channels each successively down shifted by fₒ+k(Δf/N) using an oscillator 126 and frequency multiplier 128 and sent through a notch filter 120 with Δf/N width, with k running from 1 to N. The output f each channel is rectified 96 and integrated 80. The output of all of the channels is fed into a timed 86 AND gate 88 array so that only if all of the frequency inputs occur in the proper order at the proper interval is the output a positive pulse corresponding to a “one” chirp 92. An identical circuit, not shown, generates a negative pulse corresponding to a “zero” chirp. In a commercial embodiment of the invention, these two circuits operate in parallel.

XII. Sloped Filter

(U/D 50, UD/DU 52)

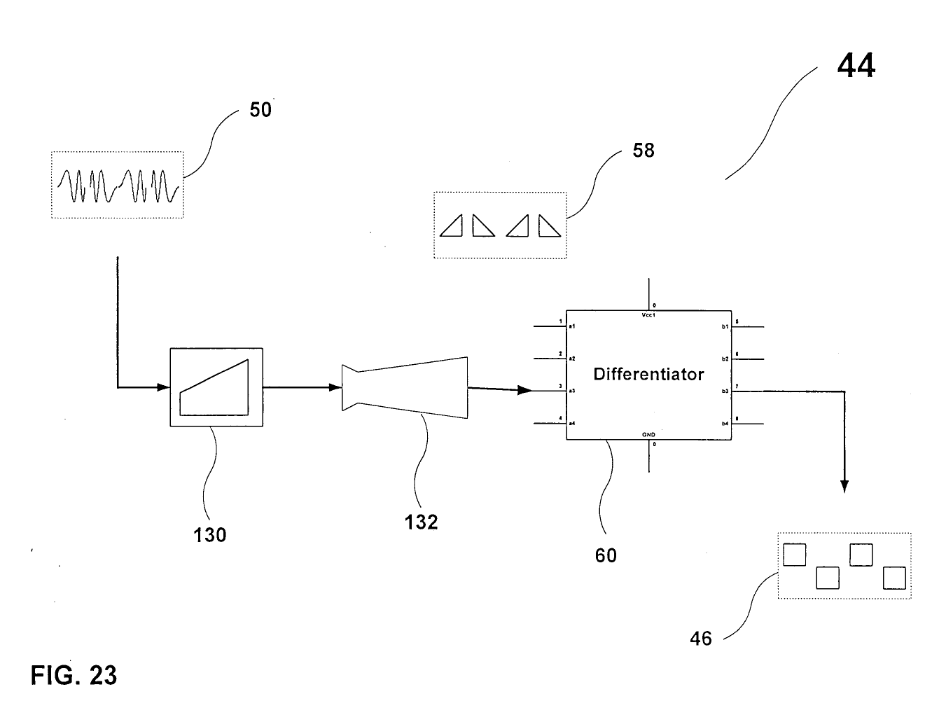

In the twelfth embodiment of the disclosed invention 44 the input signal is input to a filter 130 whose output is linearly proportional to the frequency. The result is a voltage signal whose magnitude is proportional to the input frequency. For the U/D chirp pair 50 shown in FIG. 23, the output after passing through an envelope detector 132 is triangular pulses with positive or negative slopes 58 that are differentiated 60 to give square pulses of appropriate sign 46.

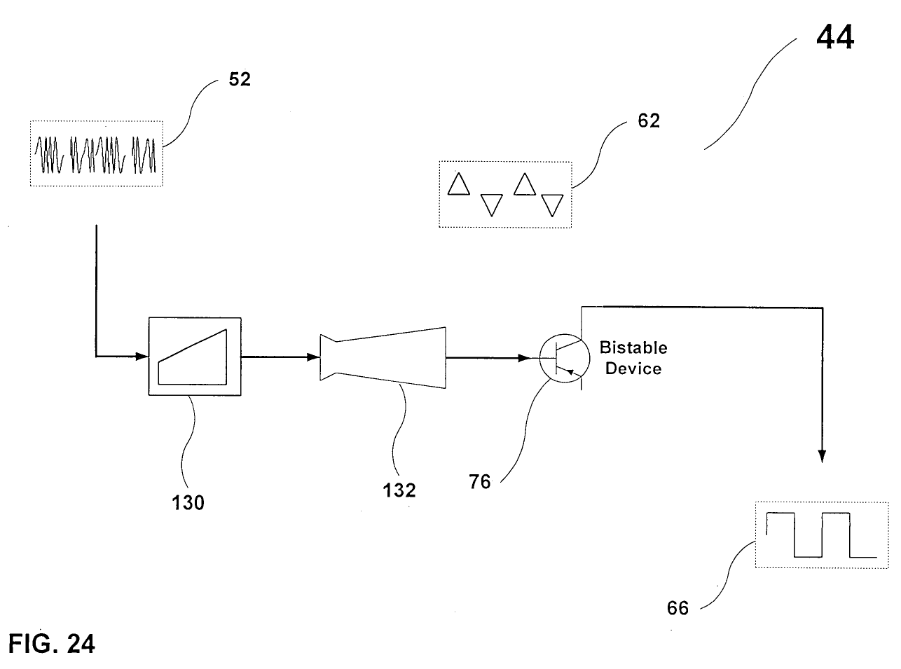

For the UD/DU chirp pair 52 shown in FIG. 24, the output after passing through an envelope detector 132 is a set of positive and negative triangular pulses 62 that are used to trigger a bistable device 76 to produce positive and negative pulses 66.

XIII. Delay Element

(U/D 50, UD/DU 52)

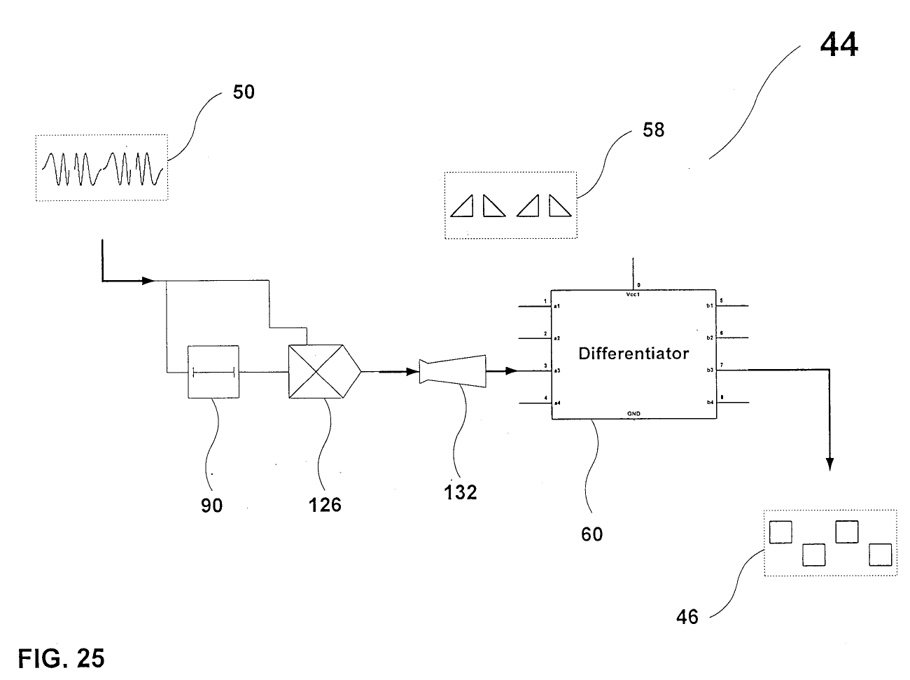

In the thirteenth embodiment of the invention 44, the input signal is directed into two paths, one of which is input to a delay element 90 and is delayed by some small time Δt and then multiplied 126 into the original signal. The output of the multiplier is sent through a an envelope detector 132. The resulting signal is proportional to the chirp frequencies times the delay. For the U/D chirp pair 50 shown in FIG. 25, the output is triangular pulses with positive or negative slopes 58 that are differentiated 60 to give square pulses of appropriate sign 46.

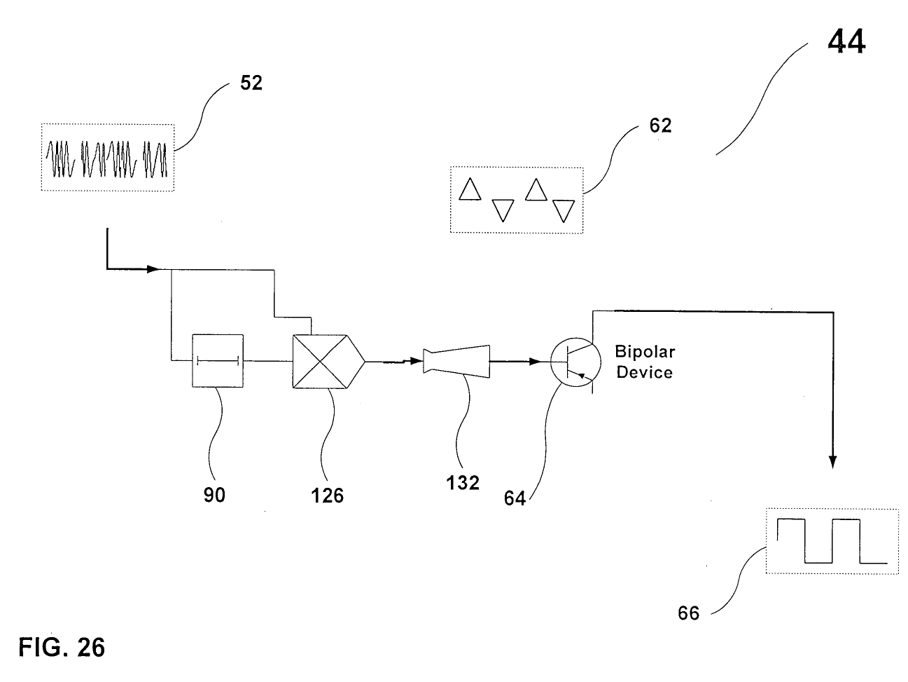

For the UD/DU chirp pair 52 shown in FIG. 26, the output after passing through an envelope detector 132 is a set of positive and negative triangular pulses 62 that are used to trigger a bipolar device 64 to produce positive and negative pulses 66.

A preferred embodiment of the disclosed invention 44 utilizes multiple frequency down shift, disclosed here as the eleventh embodiment.

The present invention encompasses methods and apparatus to enable efficient high bandwidth digital wireless communications. It is fundamentally different from existing wireless technologies which rely upon detection of changes of state to extract information from a received signal. The invention encodes information continuously across the chirp, thereby allowing more robust detection techniques that are not dependent on the detection of the edge of the transition. As a result, the disclosed invention can be used to detect chirp waveforms that are used to provide a variety of interactive information and data services, including voice, audio, data, image and compressed video to mobile users, and also to fixed users. The disclosed invention responds to increasing mobility and demands for real-time information.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the claims that follow. The various alternatives for a digital wireless communications system that have been disclosed above are intended to educate the reader about preferred embodiments of the invention, and are not intended to constrain the limits of the invention or the scope of claims. The List of Reference Characters which follow is intended to provide the reader with a convenient means of identifying elements of the invention in the Specification and Drawings. This list is not intended to delineate or narrow the scope of the claims.

### List of Reference Characters

10 Linear Frequency Up-Chirp

12 Linear Frequency Down-Chirp

14 Linear Frequency Up-Down-Chirp

16 Linear Frequency Down-Up-Chirp

18 Linear Frequency Plus-Chirp

20 Linear Frequency Minus-Chirp

22 Chirping Digital Wireless System

24 Digital Input

26 Chirping Transmitter

28 Chirping Radio Frequency Waveform

30 Chirping Receiver

32 Digital Output

34 Receive Antenna

36 Radio Frequency Receiver

38 Received Radio Frequency Input Waveform

40 Kalman Filter

42 Filtered Radio Frequency Input Waveform

44 Detector

46 Intermediate Frequency Pulses

48 Pulse Conditioner

50 Up-Chirp (“U”)/Down Chirp (“D”) Waveform

52 Up-Down-Chirp (“UD”)/Down-Up-Chirp (“DU”) Waveform

54 Plus-Chirp (“P”)/Minus-Chirp (“M”) Waveform

56 Frequency-to-Voltage (“F/V”) Converter

58 F/V Output Waveform for U/D

60 Differentiator

62 F/V Output Waveform for UD/DU

64 Bipolar Device

66 Bipolar Device Output Waveform for UD/DU

68 Analog-to-Digital (“A/D”) Converter

70 Digital Storage Register

72 Digital Signal Processor (“DSP”)

74 Digital-to-Analog (“D/A”) Converter

76 Bistable Device

78 Waveform Zero Crossing Pattern

80 Integrator

82 Integrated Waveform

84 Integrated Bistable Output

86 Timing Pulse

88 AND Logic Device

90 Delay Element

92 Output Pulse

94 Digital Signal Processor

96 Rectifier

98 Output Pulse

100 Subtracter

102 “One” Chirp Waveform

104 Negative Rectifier

106 Negative Pulse

108 “Zero” Chirp Waveform

110 Positive Pulse

112 NAND Logic Device

114 Adder

116 Small Voltage Waveform for “Zero” Chirp

118 Small Voltage Waveform for “One” Chirp

120 Notch Filter

122 Chirp Generator

124 Very Short Chirp Waveform

126 Oscillator

128 Frequency Multiplier

130 Sloped Filter

132 Waveform Envelope Detector

What is claimed is:

1. A method of extracting information from a plurality of transmitted chirp radio frequency waveforms comprising the steps of:
receiving a plurality of chirp radio frequency waveforms;
removing noise from said received chirp radio frequency waveforms; and
extracting information from said received chirp radio frequency waveforms after said noise is removed.

2. A method as recited in claim 1, further comprising the step of conditioning a plurality of intermediate frequency pulses which result from the removal of said noise to form a square wave digital output that correlates with said transmitted chirp radio frequency waveforms.

3. A method as recited in claim 1, in which noise is removed from said chirp radio frequency waveforms using a Kalman filter.

4. A method as recited in claim 1, in which the step of extracting information from said received chirp radio frequency waveforms after said noise is removed includes the following steps:
down converting said chirp radio frequency waveform by subtracting fₒ from said chirp radio frequency waveform to produce a series of U and D or UD and DU pulses containing frequencies between 0 and Δf;
sending said series of U and D or UD and DU pulses to a frequency-to-voltage converter; and
differentiating the resulting triangular shaped pulses to produce square pulses, positive for the U chirp and negative for the D chirp.

5. A method as recited in claim 1, in which the step of extracting information from said received chirp radio frequency waveforms after said noise is removed includes the following steps:
determining the zero crossings of received chirp radio frequency waveform; and
measuring and comparing the zero crossing intervals to the known patterns for U/D or UD/DU chirps.

6. A method as recited in claim 1, in which the step of extracting information from said received chirp radio frequency waveforms after said noise is removed includes the following steps:
measuring the first and last zero crossing intervals for U/D; and
measuring the first and middle crossing intervals for UD/DU.

7. A method as recited in claim 1, in which the step of extracting information from said received chirp radio frequency waveforms after said noise is removed includes the following steps:
integrating said chirp radio frequency waveform; and
determining the pulse value by evaluating the negative or positive integral that results.

8. A method as recited in claim 1, in which the step of extracting information from said received chirp radio frequency waveforms after said noise is removed includes the following steps:
rectifying said received chirp radio frequency waveform;
integrating said received chirp radio frequency waveform to give said received chirp radio frequency waveform a pulse corresponding to a “one” pulse.

9. A method as recited in claim 1, in which the step of extracting information from said received chirp radio frequency waveforms after said noise is removed includes the following steps:
splitting said received chirp radio frequency waveform;
sending said received chirp radio frequency waveform to both a “one” comparison circuit and “zero” comparison circuit;
subtracting said received chirp radio frequency waveform from the appropriate known “one” chirp wave form;
rectifying and integrating the voltage difference;
subtracting said received chirp radio frequency waveform from the appropriate known “zero” chirp wave form; and
rectifying and integrating the voltage difference.

10. A method as recited in claim 1, in which the step of extracting information from said received chirp radio frequency waveforms after said noise is removed includes the following steps:
splitting said received chirp radio frequency waveforms into a first signal and a second signal;
feeding said first and said second signals to a “one” comparison circuit and to a “zero” comparison circuit;
adding said first signal to an appropriate known “one” chirp waveform in said “one” comparison circuit;
rectifying the resulting voltage sum from the “one” comparison circuit;
integrating the rectified signal from the “one” comparison circuit;
feeding the integrated signal from the “one” comparison circuit to a first bistable device that is set to trigger at a voltage between two possible outputs;
adding said second signal to an appropriate known “zero” chirp waveform in said “zero” comparison circuit;
rectifying the resulting voltage sum from the “zero” comparison circuit;
integrating the rectified signal from the “zero” comparison circuit; and
feeding the integrated signal from the “zero” comparison circuit to a second bistable device that is set to trigger at a voltage between two possible outputs.

11. A method as recited in claim 1, in which the step of extracting information from said received chirp radio frequency waveforms after said noise is removed includes the following steps:
adding said received chirp radio frequency waveforms to a plus chirp waveform;
rectifying the sum; and
integrating the rectified signal.

12. A method as recited in claim 1, in which the step of extracting information from said received chirp radio frequency waveforms after said noise is removed includes the following steps:
feeding said received chirp radio frequency waveforms through a non-overlapping notch filter that covers the chirp frequency interval;
rectifying the output of said filter;
integrating the rectified signal;
conveying the integrated signal into an AND junction which is gated by a generated signal that is timed to the sweep of a chirp;
conveying the output of the AND junction into an AND gate array so that only if all of the frequency inputs occur in the proper order at the proper interval, a pulse corresponding to a “one” chirp is produced.

13. A method as recited in claim 1, in which the step of extracting information from said received chirp radio frequency waveforms after said noise is removed includes the following steps:
feeding said received chirp radio frequency waveforms through a non-overlapping notch filter that covers the chirp frequency interval;
rectifying the output of said filter;
integrating the rectified signal;
conveying the integrated signal into an AND junction which is gated by a generated signal that is timed to the sweep of a chirp;
conveying the output of the AND junction into an AND gate array so that only if all of the frequency inputs occur in the proper order at the proper interval, a pulse corresponding to a “zero” chirp is produced.

14. A method as recited in claim 1, in which the step of extracting information from said received chirp radio frequency waveforms after said noise is removed includes the following steps:
downshifting said received chirp radio frequency waveforms from the base frequency.

15. A method as recited in claim 1, in which the step of extracting information from said received chirp radio frequency waveforms after said noise is removed includes the following steps:
splitting said received chirp radio frequency waveforms into N channels;
successively down shifting each of said channels by fₒ+k(Δf/N) using an oscillator and a frequency multiplier;
conveying the resulting signal through a notch filter with Δf/N width, with k running from 1 to N;
rectifying and integrating the output of each channel; and
feeding the output of all the channels into a timed AND gate array so that only if all of the frequency inputs occur in the proper order at the proper interval is the output a pulse corresponding to a “one” chirp.

16. A method as recited in claim 1, in which the step of extracting information from said received chirp radio frequency waveforms after said noise is removed includes the following steps:
splitting said received chirp radio frequency waveforms into N channels;
successively down shifting each of said channels by fₒ+k(Δf/N) using an oscillator and a frequency multiplier;
conveying the resulting signal through a notch filter with Δf/N width, with k running from 1 to N;
rectifying and integrating the output of each channel; and
feeding the output of all the channels into a timed AND gate array so that only if all of the frequency inputs occur in the proper order at the proper interval is the output a pulse corresponding to a “zero” chirp.

17. A method as recited in claim 1, in which the step of extracting information from said received chirp radio frequency waveforms after said noise is removed includes the following steps:
conveying said received chirp radio frequency waveforms to a filter whose output is linearly proportional to the frequency to produce a voltage signal whose magnitude is proportional to the input frequency;
passing said voltage signal through an envelope detector; and
differentiating the output of said envelope detector to produce square pulses of appropriate sign.

18. A method as recited in claim 1, in which the step of extracting information from said received chirp radio frequency waveforms after said noise is removed includes the following steps:
conveying said received chirp radio frequency waveforms to a filter whose output is linearly proportional to the frequency to produce a voltage signal whose magnitude is proportional to the input frequency;
passing said voltage signal through an envelope detector; and
using the output of said envelope detector to trigger a bistable device to produce positive and negative pulses.

19. A method as recited in claim 1, in which the step of extracting information from said received chirp radio frequency waveforms after said noise is removed includes the following steps:
splitting said received chirp radio frequency waveforms into a first signal and a second signal;
feeding said first signal to a delay element which introduces a delay Δt;
multiplying said delayed first signal by said received chirp radio frequency waveforms; and
feeding the product to an envelope detector to generate a signal that is proportional to the chirp frequencies times the delay.
